(19) United States
(12) Patent Application Publication
(10) Pub. No.: US 2026/0170129 A1
(43) Pub. Date: Jun. 18, 2026

(54) SAFETY DEVICE AND METHOD FOR CONTINUOUSLY MONITORING THE FUNCTIONAL SAFETY OF A DIGITAL SIGNAL PROCESSOR

(71) Applicant: Infineon Technologies AG, Neubiberg (DE)

(72) Inventors: Benjamin KOLLMITZER, Pörtschach am Wörther See (AT); Friedrich RASBORNIG, Klagenfurt (AT); Gerhard PIRCHER, Villach (AT); Jens ROSENBUSCH, München (DE); Dietmar KÖNIG, München (DE); Adorjan GAVEL, Villach (AT)

(21) Appl. No.: 19/413,763

(22) Filed: Dec. 9, 2025

(30) Foreign Application Priority Data
Dec. 12, 2024 (DE) 102024137535.3

(51) Int. Cl. G06F 21/55

(52) U.S. Cl. CPC G06F 21/554; G06F 2221/034

(57) ABSTRACT

The implementation discloses an integrated circuit including a specific digital signal processor (DSP) having an associated arithmetic logic unit (ALU) and including a dedicated safety device for continuously monitoring the functional safety of this specific digital signal processor. The digital signal processor triggers a predetermined security mechanism that enables one or more specified test operations to be carried out by the ALU. The test results obtained in the process are stored in a test result register. The safety device reads out at certain times the content of the test result register and compares the content with a specified correct test result. In the event of a deviation, a fault indication is generated.

### CROSS-REFERENCE TO RELATED APPLICATION

This application claims priority to Germany Patent Application No. 102024137535.3 filed on Dec. 12, 2024, the content of which is incorporated by reference herein in its entirety.

### TECHNICAL FIELD

The present disclosure relates to a hardware-implemented integrated circuit comprising a single digital signal processor having an arithmetic logic unit and comprising a safety device for continuously monitoring the functional safety of the digital signal processor.

### BACKGROUND

Technical installations, but also automobiles, cause major material damage or danger to persons or the environment if they are not used for their intended purpose. A risk and hazard analysis is therefore created for these systems when development thereof starts. The design of the systems by applying product-specific application guidelines and standards is paramount to minimizing risk.

The other hazards identified in the risk analysis must be protected by safety devices. As part of the risk analysis, the hazards are estimated quantitatively in this case. The extent of the damage can range here from minor reparable injuries to the death of multiple people. The higher the extent of the damage and the more likely the occurrence of a loss event, the higher the level of safety to be selected, too. The application standards list different risk assessment levels. In the process industry, the SIL (Safety Integrity Level) is mostly used, which ranges from levels SIL1 to SIL4 with increasing requirements.

The so-called ASIL (Automotive Safety Integrity Level) is used in the automotive sector. The ASIL is part of the ISO standard ISO 26262 (“Road vehicles—Functional safety”) for safety-relevant electrical/electronic systems in motor vehicles. ISO 26262 defines a procedure model together with required activities and work products as well as methods to be applied in development and production. ‘Functional safety’ is often also discussed.

As the complexity of electronic components in vehicles continues to grow, the risk of malfunctions also increases. If a safety-relevant component is affected by such a malfunction, the worst case may be that people are killed. For example, if a power steering controller in a motor vehicle were to report an incorrect steering angle position when driving at speed, this could lead to an accident. In order to minimize the risk of dangerous malfunctions in safety-relevant electronic systems in the vehicle, it is advantageous if these systems are developed in accordance with relevant standards, such as the above-mentioned ISO 26262. Users include automotive manufacturers, automotive suppliers and test institutes.

ISO 26262 focuses on safety in the sense of intrinsic safety (protection of the environment from the product), which is why it is also referred to as functional safety. The normal function can be restricted or even switched off in the interests of safety (system response). It is not enough in this case that the function has been executed correctly, but the aim of development must also be that it has been executed in the correct context or that it is not executed by itself in the wrong situation. If, for example, the airbag deploys in an accident situation, the function is correct. However, if it triggers during normal driving, the function may be correct, but in the wrong context it could be a functional safety problem. The consequences for the driver's head, however, are the same in both cases, if only taking into account the effect of the airbag.

A hazard analysis produces the safety requirement level, which is classified from ASIL A to ASIL D and requires additional development measures depending on the ASIL. The risk analysis in ISO 26262 is carried out using a defined, qualitative methodology. If the risk is so low that it is not necessary to apply the standard, the risk is assigned the classification ASIL QM. Otherwise, the categorization QM or ASIL A to ASIL D can be read from a specified table for each hazard. The ASIL increases from A to D and thus the effort required by the standard's methods and specified in the respective parts also increases.

A suitable risk or hazard analysis can be created, for example, using an FMEDA (failure modes, effects, and diagnostic analysis). This is a risk analysis method commonly used in safety-critical systems, especially in the automotive and aviation industries.

For example, safety-critical systems can be categorized using a PMHF (probabilistic metric for random hardware failures) according to the definitions of ISO 26262. The term “probabilistic metric for random hardware failures” refers to a probabilistic metric used to measure or evaluate random hardware failures. The PMHF describes quantitative criteria for the residual risk of a safety target being harmed by random hardware failures. In simple terms, according to ISO 26262, the PMHF describes a metric for demonstrating the robustness of a safety architecture.

The results of the PMHF are given in FIT or using a so-called FIT rate (FIT: failures in time). The FIT rate is a unit that describes the frequency of faults. 1 FIT corresponds to one fault per 1 billion (10\hat{ }9) hours of operation.

In the context of fault tolerance and reliability in complex systems, the term SPFM (single point fault metric) is also known according to ISO 26262 definitions. The SPFM describes quantitative criteria for the effectiveness of the safety architecture with respect to the management of single point and residual faults. In simple terms, the SPFM describes a metric for the proportion of remaining dangerous faults relative to all faults. This is expressed here as a percentage.

The SPFM therefore refers to a metric that describes the risk or the impacts of a fault at a single point in a system, a so-called single point fault (SPF). A single point fault (SPF) is a fault that occurs at a single point in the system and can potentially adversely affect the entire system. This means that a fault in a single component part or component can jeopardize the functioning of the entire system or part of it. The single point fault metric (SPFM) quantifies the risk or the impacts of a fault at a single point or in a single component in a system.

The exact definitions of the PMHF, PMHF-FIT rate and SPFM can be found in ISO 26262. In this case, the same definitions also apply to this document.

When system faults used to classify the resulting risk into the different ASIL levels occur, a distinction is made between random and systematic faults. Random faults are hardware failures that occur statistically and with a reproducible probability on electronic components. The failure rates determined in functional safety can therefore only refer to random faults. The failure rates determined for random faults are based on operation under permissible operating conditions.

The aforementioned ASIL is used in various parts of ISO 26262 to recommend measures. In particular, part 5 (hardware) and part 6 (software) contain numerous tables of methods and recommendations that are dependent on the ASIL. For example, deductive analysis such as FTA (fault tree analysis) is particularly recommended only from ASIL C and ASIL D onwards.

In the automotive sector, the hardware is usually in the form of dedicated controllers, and the software is integrated in the form of firmware running on the hardware. Individual vehicle components usually have their own controllers, such as an airbag controller, an ABS controller, and the like. Since the controllers usually perform very specific and specialized tasks, particular attention is paid to efficient, e.g., fast, and safe execution of the respective task when designing the controllers. For this reason, integrated circuits (e.g., ASICs: application-specific integrated circuit) with specialized digital signal processors (DSP).

Today, different concepts exist in order to meet the safety-relevant specifications mentioned above, such as the specifications of ISO standard 26262. For example, two DSPs are installed in one controller to create fail-safe redundancy. However, this requires additional chip space in the corresponding integrated circuit, which is associated with increased costs. In addition, separate firmware must be developed for the second redundant DSP, which also leads to increased costs and increased complexity in the circuit design.

As an alternative to redundant hardware, standardized safety mechanisms can be integrated at software level, such as time watchdogs or program counter (PC) parity checks. However, these only detect an insufficient number (only approximately 10-15%) of fault conditions, such as a total failure (“no operation”) of the system, which in turn leads to an undesirably high PMHF FIT rate in the FMEDA.

In addition, existing safety mechanisms completely disregard the actual calculation unit, namely the arithmetic logic unit ALU.

It would therefore be desirable to improve existing functional safety solutions for DSPs in such a way that faults (especially SPF: single point failures) can be detected during runtime with a probability of more than 90%, while simultaneously saving precious chip space.

### SUMMARY

This can be achieved by a hardware-implemented integrated circuit (for example ASIC) as well as by a method having the features of the respective independent claims.

The innovative circuit includes a specific digital signal processor (DSP) with an associated arithmetic logic unit (ALU) and includes a dedicated safety device for continuously monitoring the functional safety of the digital signal processor (DSP). The digital signal processor (DSP) is configured to repeatedly execute a predetermined safety mechanism, wherein the safety mechanism enables one or more specified test operations (opcodes) to be carried out by the ALU, and wherein test results obtained in the process are stored in a test result register (ALU check results register). The safety device in turn is configured to read out at certain times the content of the test result register and compare this with a specified correct test result and, in the event of a deviation, to generate a fault indication.

The innovative method is used to monitor the functional safety of a specific digital signal processor (DSP) installed in an integrated circuit. The method is executed using a dedicated safety device and includes, among other things, periodic execution of a built-in safety mechanism, which is preferably compatible with ISO 26262. This safety mechanism can, for example, enable one or more specified test operations (opcodes) to be carried out by an ALU integrated in the DSP, wherein the test result is stored in a test result register (ALU check results register). The method also includes reading out the content of the test result register at specified times and comparing the content read out with a specified correct test result. In addition, the method includes generating a fault indication in the event of a detected deviation between the specified correct test result and the content read from the test result register.

Another object of the present disclosure is a computer program product for executing the method and a corresponding storage medium, in particular when the method is executed on a computer.

Upon reading the following detailed description and upon examining the attached drawings, a person skilled in the art will discern further features and advantages of the implementation, which are reproduced in particular in the dependent claims.

### BRIEF DESCRIPTION OF THE DRAWINGS

The present disclosure is shown in an example and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows a schematic block diagram of one example implementation of an innovative circuit with safety device,

FIG. 2 shows a schematic block diagram of another example implementation of an innovative circuit with safety device,

FIG. 3 shows a graph for quantitatively evaluating the frequency of calls for certain opcodes, and

FIG. 4 shows a schematic block diagram of an innovative method according to one example implementation.

### DETAILED DESCRIPTION

The implementations described here enable monitoring of the functional safety of a specific DSP (DSP: digital signal processor), which is equipped with an ALU (ALU: arithmetic logic unit), but without the need to provide an additional redundant DSP. In particular, the functional safety of the ALU can be monitored in this case. For this purpose, a dedicated safety device is provided according to the innovation and this can be configured in the form of an additional hardware component and equipped with appropriate firmware. “Dedicated” means that this one safety device is specifically assigned to this one specific DSP.

The safety device can cause precisely this one specific DSP to trigger a safety mechanism (for example in the form of a state machine), which in turn can call different functions or execute operations. For example, the safety mechanism may have a self-test function. The test results of the functions called via the safety mechanism or of the operations executed can be compared with a predefined target test result. When a deviation is detected, the safety device can output a fault indication.

For example, a DSP together with an associated ALU can be integrated into a hardware-implemented integrated circuit, such as an application-specific integrated circuit (ASIC). The DSP is the main block in the signal process chain in this case. In ISO 26262, the DSP is therefore named as the most critical architectural element in terms of functional safety.

Today, different concepts exist in order to meet the safety-relevant specifications, such as the specifications of ISO 26262 mentioned above. For example, two DSPs are installed in one controller to create fail-safe redundancy. However, the redundant DSP requires additional chip space in the corresponding integrated circuit, which is associated with increased costs. In addition, separate firmware must be developed for the second redundant DSP, which also leads to increased costs and increased complexity in the circuit design.

As an alternative to redundant hardware, standardized safety mechanisms can be integrated at software level, such as time watchdogs or program counter (PC) parity checks. However, these only detect an insufficient number (only approximately 10-15%) of fault conditions, such as a total failure (“no operation”) of the system, which in turn leads to an undesirably high PMHF FIT rate in the risk assessment (e.g., FMEDA).

In addition, existing safety mechanisms completely disregard the actual calculation unit, namely the arithmetic logic unit ALU.

All these problems can be addressed by an innovative circuit (including DSP and ALU), wherein the specific DSP used in this case has a dedicated safety device, which in turn can execute a safety mechanism to verify the functional safety of the DSP, and in particular the ALU.

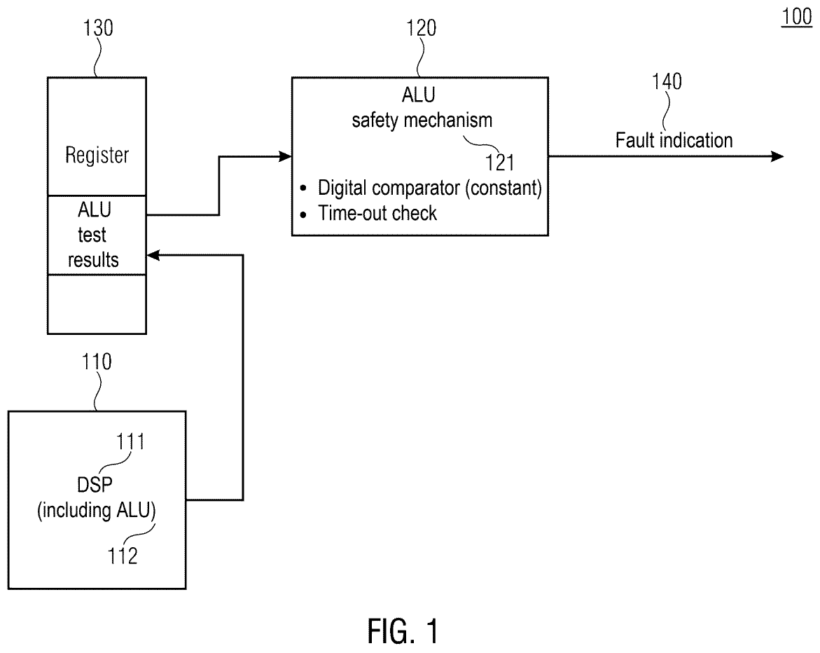

FIG. 1 shows a schematic block diagram of a first example implementation of an innovative hardware-implemented integrated circuit 100 with a first functional block 110 including, among other things, a DSP 111 and an ALU 112.

The DSP 111 is one specific DSP, e.g., a single DSP, which is responsible for executing a particular central chip functionality. As will be explained in more detail below, the circuit 100 innovatively has a dedicated safety device 120, which is specifically responsible for this one specific DSP 111 or for the associated ALU 112. Of course, additional DSPs (not explicitly illustrated here) with corresponding ALUs may be present in a circuit 100 or in a controller, wherein, in this case, each specific DSP with ALU would be assigned its own dedicated safety device. Purely for the sake of simplicity, however, only a single specific DSP 111 with an associated single dedicated safety device 120 is described below as an example.

The safety device 120 shown in FIG. 1 is used for continuously monitoring the functional safety of this one specific DSP 111 including the associated ALU 112. As illustrated here by way of example, the safety device 120 may, for example, have a digital comparator on the hardware side. As an alternative or in addition, the safety device 120 can perform a time-out check or window check. The time-out check verifies whether the test result is generated by the ALU 112 within a certain time. The window check verifies whether the test result is generated by the ALU 112 within a certain period of time. The time-out check therefore only identifies time-outs; the window check identifies time-outs from underrunning and overrunning.

At a functional level, the safety device 120 includes a safety mechanism 121, which can be triggered by the DSP 111 and/or the ALU 112. The safety mechanism 121 can be triggered repeatedly, e.g., multiple times in succession.

The safety mechanism 121 is used to verify the above-mentioned functional safety of the DSP 111 or the ALU 112. When the safety mechanism 121 is triggered, one or more specified operations (triggered by so-called opcodes) are executed by the ALU 112.

An opcode (operation code) is the part of a machine instruction that indicates which operation or action the CPU should perform. It is a central component part of a processor's assembly language and machine language. Opcodes are essential for low-level programming because they directly represent the commands that control a processor's hardware.

### Functions and Features of an Opcode:

1. Operation: The opcode specifies the type of operation to be carried out, for example addition, subtraction, multiplication, logic operations, data movement (for example loading or saving values) or control instructions.
2. Machine language: Opcodes are usually encoded in binary form, with each CPU architecture having its own set of opcodes. For example, the opcode for an addition might be different in one architecture than in another.
3. Instruction format: An instruction often consists of an opcode and operational data (operands) that indicate the variables or storage locations to which the operation is applied. One example might look like this:
   Opcode: ADD
   Operands: R1, R2 (the registers to be added)
4. Instruction set: The collection of opcodes that a processor understands is called an instruction set. This defines what operations the processor can execute.

### Examples of Opcodes:

MOV: Moves data from one location to another.
ADD: Adds two values.
SUB: Subtracts one value from another.
JMP: Jumps to another address in the program.

The safety mechanism 121 calling the opcodes can be executed, for example, in the form of an automatic test method, which can be integrated into electronic systems or hardware components, in order to check its own functionality without external testing devices. This enables a system to self-diagnose and ensure that it is functioning properly.

The safety mechanism 121 according to the implementation may be compatible with the specifications of ISO 26262. The safety mechanism 121 according to the implementation represents a technical solution implemented by E/E functions or elements or by other technologies to identify and mitigate or tolerate faults or to control or prevent failures in order to maintain the intended functionality or to achieve or maintain a safe state. The safety mechanism 121 according to the implementation can be implemented within a vehicle-specific system to prevent malfunctions leading to single point faults and to prevent malfunctions leading to latent faults.

The safety mechanism 121 according to the implementation may be able to transfer the vehicle-specific system to a safe state or to keep it in this state. As an alternative or in addition, the safety mechanism 121 according to the implementation may be able to warn the vehicle driver so that they can check the effects of the fault as defined in the functional safety concept according to ISO 26262.

The main aims of the safety mechanism 121 according to the implementation are:
Early identification of faults: The system itself can detect faults during production, after commissioning or during operation.
Ease of maintenance: Integrated self-tests allow systems to perform periodic checks without the need for external testing devices or manual intervention.
Cost savings: Since external testing apparatus are omitted or reduced, the total cost can be reduced.
Reliability: Self-test functions can make systems more robust by alerting them to malfunctions at an early stage.

Examples of applying the safety mechanism 121:
Processors: In microprocessors, the safety mechanism 121 according to the implementation can be used to test the correct functioning of the internal circuits.
Automotive industry: In modern cars, the safety mechanism 121 according to the implementation can be used to monitor the electronics such as sensors and controllers.

The safety mechanism 121 according to the implementation can be executed at regular intervals or on demand (for example at the start of the system) in order to test the integrity and functionality.

However, the innovative safety mechanism 121 integrated in the safety device 120 can also be implemented in another form. As mentioned at the outset, when the safety mechanism 121 is triggered, one or more specified test operations (triggered by so-called opcodes) can be executed by the ALU 112.

The test results obtained in the process can then be stored in a test result register 130. For example, the test result register 130 may be a 16-bit register. The safety device 120 can read out the content of the test result register 130 at certain times. The test result register 130 can be deleted during or after readout by the safety device 120 (so-called “clear-on-read”). The test result read from out the test result register 130 can then be compared with a specified correct test result. The correct test result corresponds to an expected positive test result. If the comparison between the actual test result and the specified correct test result shows a deviation, a fault indication 140 can be generated.

For example, the specified correct test result may have been calculated in advance. It may be stored in a memory, such as a register bank. For example, the memory may be configured in the form of a look-up table. The previously mentioned comparison between a test result actually obtained and a correct test result stored in the memory (for example LUT) can be carried out, for example, in the form of a target/actual value comparison.

In one implementation, it is possible to indicate that a fault has occurred, but not exactly which fault has occurred. In an alternative implementation, a fault designation can also be displayed. In both cases, it is conceivable that a certain action, such as a chip reset, will be executed after a fault has been detected.

The aim of the safety mechanism 121 according to the implementation is to achieve a safe state. This can be achieved, for example, by transmitting a fault message, by a chip reset, etc. Thus, the safety mechanism 121 according to the implementation can ensure that a system in which the safety mechanism 121 according to the implementation is implemented does not result in a hazardous event.

In summary, it can thus be stated for the example implementation shown in FIG. 1 that the DSP 111 can perform at regular intervals a certain function (for example a test function) containing one or more opcodes to be tested. The DSP 111 then stores the result of the function called in the test result register 130. The safety device 120 compares, also at regular times, the content of the register 130 with a potentially precalculated correct result and deletes this register 130 upon reading. In the event of a mismatch, a fault message is generated and an optional chip reset can be triggered, for example.

In the cases described above, the safety mechanism 120 may include the execution of a single operation or a single opcode. The test result stored in the test result register 130 contains the actual result of this individual operation, and the specified correct test result may be a precalculated expected result of this individual operation.

In an alternative example implementation, the safety mechanism 121 may include the execution of multiple individual operations. In this case, the test result stored in the test result register 130 could include the actual individual results of these multiple executed operations, and these actual results could in turn be stored in a compressed manner in a readable code. For example, this may be a checksum, such as a CRC code or a hash code.

In other words, an alternative configuration could thus make provision for a checksum, such as a CRC or HASH code, of an executed sequence to be stored as the test result in the register 130, instead of storing each individual test result. The comparison could then be performed using this compressed result. This alternative can result in savings in chip space.

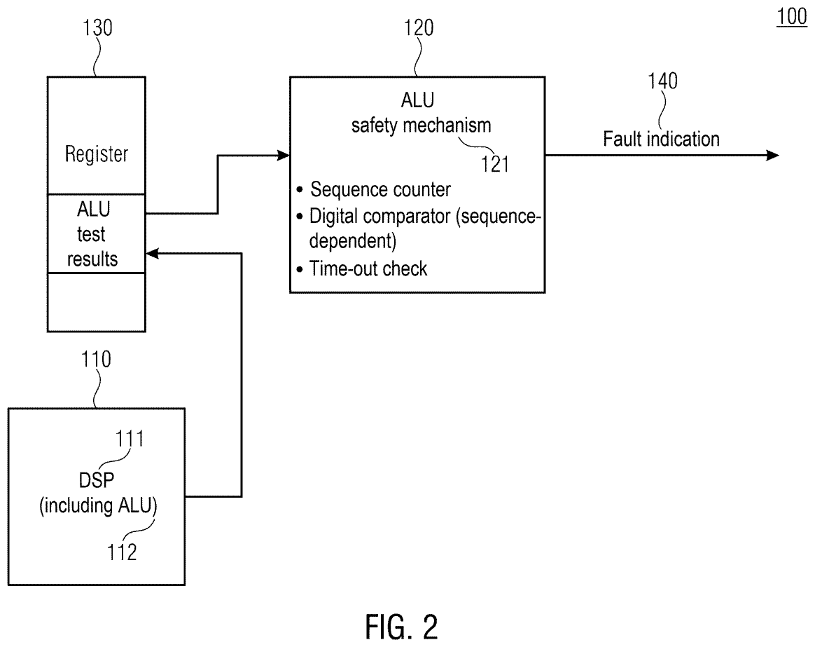

FIG. 2 shows another conceivable example implementation. This example implementation is essentially similar to the example implementation discussed previously with reference to FIG. 1, which is why elements with the same or similar functions are provided with the same reference signs. To avoid repetition, please refer to the discussion above in this regard.

One difference is that here the safety mechanism 121 includes a sequential execution of a sequence of operations (triggered by a sequence of opcodes). In this case, the safety device 120 may have a sequence counter here.

With this implementation, it is additionally possible to check whether the time sequence of the successively called opcodes is correct. The sequence counter can for this purpose count and monitor whether the opcodes have been executed in the correct time sequence.

Thus, the test result stored in the test result register 130 may include the individual, sequentially listed, actual results of the sequence of executed operations. The sequence counter, in turn, can then count the individual operations called during the execution of the safety mechanism and monitor their correct sequential execution by matching the respective, sequentially listed actual results of the individual operations with respective pre-stored expected results according to its current counter reading; in other words, an expected result can be assigned to each counter reading.

For example, the DSP 111 or the ALU 112 can perform at regular intervals certain subfunctions (for example test functions) containing the opcodes to be checked. The DSP 111 can then store the result of these functions sequentially in the test result register 130. The safety device 120 can then, also at regular times, compare the content of the test result register 130 with the results that depend on the sequence counter. These target results in turn may possibly be precalculated and may differ for different values of the sequence counter. In the event of a mismatch, a fault message 140 can be generated, for example a chip reset is triggered. The advantage of this implementation is an increased scope of diagnostics, since different commands (opcodes) and/or different arguments (operands) can be monitored.

The following table 1 shows an example overview of command classes and associated operands.

TABLE 1

| Command class | Input | Output |
|---|---|---|
| Load | Memory address | Destination address, flags |
| Store | Source register | Memory address |
| Branch | Program counter | |
| | address/increment, | |
| | (flags) | |
| Movement (Move/Jump) | Source register | Destination address, flags |
| Logical mathematics | Source register | Destination address, flags |
| Immediate logic | Constant, register | Register, flags |
| Comparison | R0, source register | Destination address, flags |

Table 1 shows eight work registers. Carry zero flags and negative flags are also covered in the table. The command classes identify the operations to be performed, which are encoded by opcodes, depending on the command set of the underlying microcontroller.

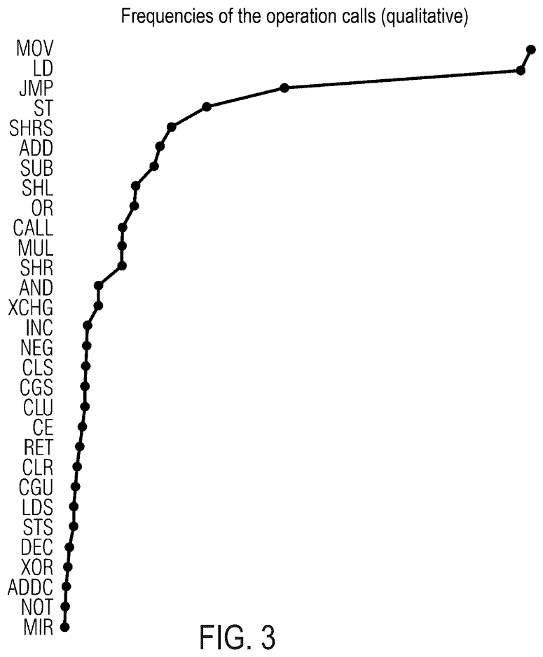

FIG. 3 shows an example graph indicating the purely qualitative frequency of calls of the individual opcodes. The respective opcodes are listed on the x axis. The number of calls of the respective opcode is plotted (purely qualitatively) along the y axis. It can be seen here, for example, that the movement commands encoded by the opcode “MOV” are called most often by far, followed by the load commands encoded by the opcode “LD” and the jump commands encoded by the opcode “JMP”.

Accordingly, it makes sense for the innovative safety device 120 to test the most frequently used opcodes to verify the functional safety of the DSP 111 or the associated ALU 112.

According to one example implementation, the one or more specified operations (opcodes), which the ALU 112 calls during execution of the safety mechanism 121, may include at least one LOAD command or a STORE command.

According to another example implementation, the one or more specified operations (opcodes), which the ALU 112 calls during execution of the safety mechanism 121, may include at least one command for carrying out an arithmetic calculation (for example ADD, SUB, MUL).

According to another example implementation, the one or more specified operations (opcodes), which the ALU 112 calls during execution of the safety mechanism 121, may include at least one JUMP command or a MOVE command.

Thus, the verification of only a subset of the entire instruction set, e.g., a subset of all existing opcodes, may be sufficient to test the functional safety of the DSP 111 or the associated ALU 112. This subset may contain the most frequently called opcodes.

According to a conceivable example implementation, the safety device 120 may be configured to perform the safety mechanism 121 using only a predetermined subset (for example less than 50%) of all operations (opcodes) present in the entire instruction set.

Even verifying such a subset may be sufficient to detect more than one predefined number (for example more than 90%) of all randomly occurring hardware faults in the ALU 112. This is the so-called diagnostic coverage, which represents an important quality feature of the safety device 121 according to the implementation.

In summary, FIG. 3 shows a non-limiting example for calculating functional fault coverage for the proposed safety mechanism 121, based on a specific DSP algorithm. For example, the instruction calls with the highest call frequency can be stored in the safety device 121 according to the implementation in order to maximize the diagnostic coverage achievable. The diagnostic coverage ratio is the sum of the frequency of the observed instruction calls, as measured by the total instruction calls of the firmware.

Another advantage of this innovation is the potential to save chip space. As schematically shown in FIGS. 1 and 2, the safety device 120 may be configured in the form of a dedicated hardware block coupled to the DSP 111, and the safety mechanism 121 in turn may be implemented in the form of firmware integrated in the hardware block. This results in significant chip space savings compared to a second fully redundant DSP. The development effort is also significantly lower.

Thus, this small hardware block is sufficient to realize the innovative safety device 120 disclosed herein, which in turn can trigger the safety mechanism 121 implemented therein. Thus, a second redundant DSP is not required, which allows a huge saving of precious chip space. Compared to a redundant DSP, the innovative safety device 120 requires a significantly reduced chip space, for example only 5% to 10% of the chip space, which would otherwise be required by a redundant DSP. This saves about 90% to 95% of the chip space compared to a redundant DSP

Another important advantage is the way in which the innovative safety mechanism 121 can be implemented. According to one conceivable implementation, the safety device 120 may include a diverse implementation of the safety mechanism 121. This may be particularly advantageous in order to identify and avoid systematic faults.

A diverse implementation refers here to the concept of using multiple different implementations of a system, a function or an algorithm to increase safety, reliability, or fault tolerance. This concept is often used in safety-critical applications and software development. Key features and advantages:
1. Redundancy: The use of different implementations can eliminate or mitigate potential fault sources. If one implementation fails or is faulty, the others can continue to operate correctly.
2. Fault tolerance: Diverse implementations can help to minimize the impact of faults. This is particularly important in safety-critical fields such as aviation, the automotive industry or medical technology.
3. Safety: In safety-relevant systems, different implementations can protect against different attack vectors or failure scenarios. An attacker would have to overcome several different approaches to compromise the system.
4. Prevention of common-mode failures: The diversity of implementations minimizes the risk that a common problem will affect all implementations (for example a fault in the underlying logic or in the design). Thus, the probability of systematic faults in the DSP as well as in the safety device 120 according to the implementation including the safety mechanism 121 can also be significantly reduced.

A diverse implementation is therefore an important strategy for improving the robustness and safety of systems.

Different verifications are listed purely by way of example and in a non-exhaustive manner below, these being able to be carried out using the innovative safety device 120 in order to check the functional safety of the DSP 111 or the associated ALU 112.

### (1) Memory Operations and Bus Tests (Implemented in Hardware):

The safety device 120 should indicate a fault if it detects the following:
   Bit flips on the address bus¹) or
      an incorrect access type (read/write)²)
      while the firmware part of the internal safety mechanism 121 is running³).
         Comments regarding the footnotes:
1) This can be achieved by providing two registers (which are used both for the result check and for providing inputs to the firmware part of the safety mechanism 121) at complementary addresses, so that accesses to these registers switch over all address bits.
2) This function block expects the firmware part of the safety mechanism 121 to implement a certain sequence of the LOAD/STORE instructions, which it directly monitors by monitoring the memory bus of the DSP 111 (does not correspond to the bus of the bitmap, which is also intended to detect fault in the address decoder of the bitmap).
3) This means that it should take at least the time of execution of the firmware part of the safety mechanism 121 to reliably detect a fault.

Such an example implementation can therefore provide, for example, that the safety mechanism 121 includes the execution of a hardware-implemented verification of memory access operations (for example read/write), wherein the memory bus is monitored for this purpose in order to detect faults that occur in the address decoder.

In this case, the test result stored in the test result register 130 contains the actually executed memory access operation stored on the memory bus, and the specified correct test result in turn corresponds to an expected memory access operation.

The safety device 120 may indicate a fault if an incorrect memory access operation (for example read instead of write) is detected during the execution of the safety mechanism 121.

The previously mentioned bit flips, which can be detected with the aid of two complementary registers, can in turn be part of a so-called “stuck-at” check. A stuck-at fault originally refers to a term from digital circuit technology. It describes a frequently occurring fault in digital circuits, especially in integrated circuits (ICs) or hardware components.

In the event of a stuck-at fault, a line or a signal in the circuit behaves as if it always had a fixed value (either a logic “0” or a logic “1”), regardless of the input values that would normally control the value of the signal. This means that the affected line “gets stuck” and can no longer change to its intended state.

There are two main types of stuck-at faults:
Stuck-at-0 (SA0): The signal remains constant at “0”, regardless of the inputs.
Stuck-at-1 (SA1): The signal remains constant at “1”, regardless of the inputs.

A stuck-at fault can significantly affect the functioning of a digital circuit, as the affected line no longer correctly switches between possible states, resulting in incorrect calculations or operations. For example, in a logic gate (for example AND or OR), if one of the input lines is always “0” due to a stuck-at fault (stuck-at-0), the gate cannot calculate the correct output.

In order to detect stuck-at faults, a test pattern creating process is usually used, in which certain input combinations (tests) are used to check whether all lines in the circuit are functioning properly or if they are incorrectly stuck at a fixed value.

The innovative safety mechanism 120 can achieve this by using two specific registers located at complementary addresses, wherein, in the case of a stuck-at fault of an address bit in one of the registers, the register in question can no longer be addressed. If the safety device 121 detects such a stuck-at fault on the address bus, a fault can be displayed.

### (2) Branch Operations Check—Implemented in Hardware:

The safety device 120 is intended to indicate a fault if faults in branch operations due to missing or incorrect¹) write accesses are indirectly detected during the execution of the firmware part of the safety mechanism 121.

Comment regarding the footnotes:
1) It is expected that incorrectly executed branching commands on the memory bus will become visible either as a result of completely missing write access procedures that are to be performed at certain times or as write access procedures with unexpected or incorrect data.

Such an example implementation can therefore provide, for example, that the safety mechanism 121 includes the execution of a hardware-implemented check of jump and/or branch operations, wherein, for this purpose, the memory bus is monitored to determine whether the subsequent write operation takes place at the correct time and/or using the correct data after a jump or branch operation has been executed.

In this case, the test result stored in the test result register 130 contains the actual time and/or the actual data set of the subsequent write operation, and the specified correct test result includes an expected time and/or an expected data set of the subsequent write operation.

The safety device 120 can indicate a fault if the following write operation has taken place at an incorrect time and/or using incorrect data after the jump or branch operation has been executed.

Another, more direct way would be to look at the program counter (sequence counter) or the ROM address outputs. However, a lack of pipeline flush signals and the dual ROM mode make it difficult to evaluate this information from the outside.

Such an example implementation can therefore provide, for example, that the safety mechanism 121 includes the execution of a hardware-implemented check of jump and/or branch operations, wherein the internal program counter (PC: program counter or sequence counter) is evaluated for this purpose.

The test result stored in the test result register 130 contains the current address entry of the program counter, and the specified correct test result contains the expected destination address of the jump or branch operation.

The safety device 120 can indicate a fault if the actual destination address displayed in the program counter does not match the expected destination address after the jump or branch operation has been executed.

### (3) Register, Logic, Mathematics and Comparison Tests (Implemented in Hardware):

The safety device 120 is intended to indicate a fault if it detects a mismatch between the delivered and the expected result of register, logic, mathematics and comparison operations during the execution of the firmware part of the safety mechanism 121.

Such an example implementation can therefore provide, for example, that the safety mechanism 121 includes the execution of a hardware-implemented check for correct execution of at least one of the following operations:
a register access operation,
a logical operation,
an arithmetic operation, or
a comparison operation.

The test result stored in the test result register 130 contains the actual result of the respectively executed operation, and the specified correct test result contains an expected result of this operation.

The safety device 120 can indicate a fault if the actual test result stored in the test result register 130 does not match the expected test result.

### (4) Flag Checks (Implemented in Hardware):

The safety device 120 is intended to indicate a fault if it detects a mismatch between the provided and the expected flag vector (carry-zero flags and negative flags are also covered) during the execution of the firmware part of the safety mechanism 121.

The safety mechanism 121 loads at least one constant value from the bitmap and possibly other constant values from the ROM, performs arithmetic summation, subtraction, multiplication and bit shift operations on the loaded values, and stores the result in a specific bitmap register.

### Note:

The MOVE SPECIAL and STORE instructions do not change flags. Therefore, the flags visible in the debugging register S0 can be moved to a working register and then written to a register of the DSP block for the purpose of verification.

Such an example implementation can therefore provide, for example, that the safety mechanism 121 includes the execution of a hardware-implemented check of status bits or status flags that are set by an operation called during the self-test function.

The test result stored in the test result register 130 contains the status bit or status flag actually set by this operation, and the specified correct test result includes a status bit or status flag expected by this operation.

The safety device 120 can indicate a fault if the actual status bit or status flag does not match the expected status bit or status flag.

The status bits or status flags can in this case include at least one of the following flags:
a carry flag,
a zero flag, or
a negative flag.

### 5) Instruction Set Verification (Implemented in Firmware):

When the instruction set is checked, the safety mechanism 121 loads at least one constant value from the register bank (for example bitmap) and possibly other constant values from the ROM, performs arithmetic sum, subtraction, multiplication and bit shift operations on the loaded values, and stores the result in a specific register bank entry.

Such an example implementation may therefore provide, for example, that the safety mechanism 121 includes a firmware-implemented check of the entire instruction set by loading constant values from different sources (for example bitmap or ROM), and wherein bitshift operations and/or arithmetic operations are executed using these constant values.

The test result stored in the test result register 130 contains the actually obtained result of the operation respectively carried out, and the specified correct test result contains an expected result of the respective operation.

The safety device 120 can indicate a fault if the actually obtained result does not match the expected result.

Another advantage of the innovative concept described here is that the functional safety check of the DSP 111 or the ALU 112 can be carried out very quickly.

One example implementation may provide, for example, that the safety device 120 is configured to repeat the reading of the content of the test result register 130 and the comparison with the specified correct test result in a safety-critical time interval (t_safety), which is significantly shorter than a predefined fault handling time interval. The safety-critical time interval (t_safety) describes the time between the occurrence of a fault and the reaching of a safe state (for example transmission of a fault message). For example, the safety-critical time interval (t_safety) may be 2 ms or shorter.

However, the predefined fault handling time interval just mentioned may be, for example, the fault handling time interval (FHTI) defined in the ISO 26262:2018 standard.

The term “fault handling time interval” refers to the time period in which a fault or a malfunction in a system is to be detected, processed and corrected. It is a defined time period in which measures for fault elimination or handling must be initiated after a problem or fault has occurred. The FHTI is thus the time period consisting of the fault detection time interval and the fault response time interval.

A short fault handling time interval means that the system must respond to faults within a narrow time frame, while a longer interval may allow more scope for fault handling. The goal is always to minimize the impact of faults and maximize system availability.

The subject matter of the present disclosure is also a method for continuously monitoring the functional safety of a specific digital signal processor—DSP—111 installed in an integrated circuit 100.

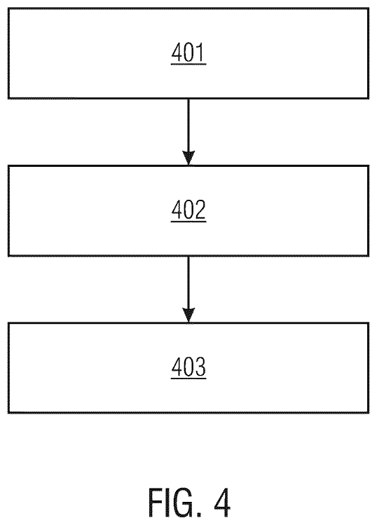

FIG. 4 shows a schematic block diagram of a corresponding innovative method that is carried out using a dedicated safety device 120 and includes the following steps:

Block 401 includes periodic execution of a built-in safety mechanism 121, wherein the safety mechanism 121 allows one or more specified operations to be carried out by an associated arithmetic logic unit—ALU—112 integrated in the digital signal processor 111, and test results obtained thereby are stored in a test result register 130.

Block 402 includes reading out the content of the test result register 130 at specified times and comparing the content read with a specified correct test result.

Block 403 includes generating a fault indication in the event of a detected deviation between the specified correct test result and the content read from the test result register 130.

In summary, the present innovative concept describes an alternative approach for applications that are relevant for functional safety (mainly ASIL A and ASIL B, as well as to a limited extent also for ASIL C and ASIL D) (for example electronic power steering, etc.) and only have a single DSP for the execution of the central chip functionality, which can be monitored by a small and diversely implemented additional circuit (=safety device).

Only one specific central DSP 111 is required, e.g., the use of one or more additional redundant DSPs, e.g., additional DSPs with identical or similar functionality or implementation to the central DSP, can be omitted.

This reduces the chip space and the complexity effort required to monitor the central DSP 111 to an absolute minimum while simultaneously ensuring adequate diagnostic coverage. The concept offers online coverage in the application within a specified safety timing (e.g., t_safety for FTTI or FHTI), in particular against single point faults.

The innovative concept described herein can be used, for example, in at least one of the following areas of application:
automotive applications (ATV),
windshield wipers,
electronic power steering (ASIL D),
motor commutation,
electric drive train,
linear motion measurement,
angle measurement,
ABS and other applications relevant to driving safety.
   Summary and advantages of the innovative concept:
Only a single DSP 111 and the implementation of software/firmware is required to perform the most important signal processing tasks, protocol generation, NVM data transmissions (NVM: non-volatile memory), etc.
The innovative safety device 120 can be configured in the form of a very simple, cost-efficient and small digital state machine with low complexity.
The innovative safety device 120 can be configured in the form of a diverse implementation with several different alternatives, for example to detect systematic faults.
The innovative safety device 120 makes high diagnostic rates of over 90% possible to monitor a single DSP 111. This may be desirable in order to achieve targets for the single point fault metric and associated required FIT rates, for example for ASIL applications.
The innovative safety device 120 can be implemented as a digital state machine, and the verification of this digital state machine can be cheaper/optimized in terms of cost compared to a mixed-signal implementation. In addition, the innovative concept described herein can contribute to an increase in functional safety.
The innovative safety device 120 provides a very simple safety mechanism 121 for a specific single DSP 111, which provides cost-effective online coverage and avoids the complexity of additional DSPs (for example lock-step approach).
The innovative safety device 120 is fully transparent for the end customer. The end customer does not need to implement an external safety mechanism for a DSP that must be documented in a safety guide.
The innovative safety device 120 can be used for cost-effective monitoring of a single DSP for functional safety applications in the automotive industry.
High diagnostic rate: The innovative safety device 120 detects a high number (50% to 60%, in some cases up to 90%) of randomly occurring hardware failures of the ALU 112 in the DSP 111.
Fast diagnostics: The innovative safety device 120 executes the safety mechanism 121 with a high repetition rate, which is below specified limit values t_{safety}, for example t_{safety}<2 ms.
The innovative safety device 120 can (using firmware versions of the safety mechanism 121) perform arithmetic calculations (for example additions, multiplications, subtractions and shift operations) with constant input values and store the results in a dedicated bitmap section (test result register 130); this can also include LOAD, STORE, MOVE and JUMP commands.
The innovative safety device 120 can be configured in the form of a separate and independent digital hardware block, which reads the results and compares them with expected values; in the event of a fault, a fault output can be generated. As an alternative or in addition, a chip reset and/or a reset of the digital part (for example including the DSP 111) can be carried out.

It should be pointed out that the description and the drawings only illustrate the principles of the proposed methods and apparatuses. A person skilled in the art will be capable of implementing different arrangements which, although they are not expressly described or shown here, embody the principles of the implementation and are contained within the scope thereof. In addition, all examples and implementations outlined in the present document are intended fundamentally and expressly for explanatory purposes only, in order to help the reader understand the principles of the proposed methods and devices. In addition, all statements in this document that describe principles, aspects and implementations of the implementation and specific examples thereof are also intended to encompass their equivalents.

### Aspects

The following provides an overview of some Aspects of the present disclosure:

Aspect 1: A hardware-implemented integrated circuit comprising: a specific digital signal processor having an associated arithmetic logic unit (ALU), and a dedicated safety device for continuously monitoring a functional safety of the specific digital signal processor, wherein the specific digital signal processor is configured to: repeatedly execute a predetermined safety mechanism, wherein the predetermined safety mechanism enables one or more specified test operations to be carried out by the associated ALU, and wherein test results obtained from the one or more specified test operations are stored in a test result register, and wherein the dedicated safety device is configured to: read out at certain times content of the test result register, compare the content with a specified correct test result, and, in the event of a deviation of the content from the specified correct test result, generate a fault indication.

Aspect 2: The integrated circuit as provided in Aspect 1, wherein the specified correct test result is calculated in advance and stored in a memory.

Aspect 3: The integrated circuit as claimed in any of Aspects 1-2 wherein the specified correct test result is stored in a register bank.

Aspect 4: The integrated circuit as claimed in any of Aspects 1-3, wherein the dedicated safety device is in the form of a hardware block coupled to the specific digital signal processor, and wherein the security mechanism is implemented in the form of firmware integrated in the hardware block.

Aspect 5: The integrated circuit as claimed in any of Aspects 1-4, wherein the dedicated safety device includes a diverse implementation of the predetermined safety mechanism.

Aspect 6: The integrated circuit as claimed in any of Aspects 1-5, wherein the predetermined safety mechanism involves the execution of a single operation, wherein a test result stored in the test result register includes an actual result of the single operation, and wherein the specified correct test result includes a precalculated expected result of the single operation.

Aspect 7: The integrated circuit as claimed in any of Aspects 1-6, wherein the predetermined safety mechanism involves the execution of multiple single operations, wherein the test results stored in the test result register include actual individual results of the multiple single operations, and the actual individual results are stored in a compressed manner in a readable code.

Aspect 8: The integrated circuit as provided in Aspect 7, wherein the readable code is a checksum.

Aspect 9: The integrated circuit as claimed in any of Aspects 1-8, wherein the dedicated safety device is configured to delete the test result register during or after readout of the test result register so that a new test result can then be stored in the test result register.

Aspect 10: The integrated circuit as claimed in any of Aspects 1-9, wherein the predetermined safety mechanism includes a sequential execution of a sequence of operations, wherein the test results stored in the test result register include individual, sequentially listed, actual results of the sequence of operations, and wherein the dedicated safety device has a sequence counter which is configured to count an execution of the sequence of operations and monitor whether the sequence of operations have been executed sequentially.

Aspect 11: The integrated circuit as provided in Aspect 10, wherein the sequence counter is configured to monitor a correct sequential execution by matching the individual, sequentially listed, actual results of the sequence of operations with respective pre-stored expected results according to a current counter reading of the sequence counter.

Aspect 12: The integrated circuit as claimed in any of Aspects 1-11, wherein the one or more specified operations executed by the associated ALU include at least one command for performing an arithmetic calculation.

Aspect 13: The integrated circuit as claimed in any of Aspects 1-12, wherein the one or more specified operations executed by the associated ALU include at least one LOAD command or a STORE command.

Aspect 14: The integrated circuit as claimed in any of Aspects 1-13, wherein the one or more specified operations executed by the associated ALU include at least one JUMP command or a MOVE command.

Aspect 15: The integrated circuit as claimed in any of Aspects 1-14, wherein the predetermined safety mechanism includes the execution of a hardware-implemented verification of memory access operations, wherein a memory bus is monitored for this purpose in order to detect faults that occur in an address decoder, wherein a test result stored in the test result register includes a memory actually executed access operation stored on the memory bus, wherein the specified correct test result is an expected memory access operation, and wherein the dedicated safety device is configured to indicate a fault if an incorrect memory access operation is detected during the execution of the predetermined safety mechanism.

Aspect 16: The integrated circuit as claimed in any of Aspects 1-15, wherein the predetermined safety mechanism includes the execution of a hardware-implemented stuck-at check on the address bus by using two specific registers located at complementary addresses, wherein, in the case of a stuck-at fault of an address bit in one of the registers, the register in question can no longer be addressed, and wherein the dedicated safety device is configured to indicate a fault when a stuck-at fault is detected on the address bus.

Aspect 17: The integrated circuit as claimed in any of Aspects 1-16, wherein the predetermined safety mechanism includes the execution of a hardware-implemented check of jump and/or branch operations, wherein, for this purpose, a memory bus is monitored to determine whether a subsequent write operation takes place at a correct time and/or is using correct data after a jump or branch operation has been executed, wherein the test result stored in the test result register contains the actual time and/or the actual data set of the subsequent write operation, wherein the specified correct test result includes an expected time and/or an expected data set of the subsequent write operation, and wherein the dedicated safety device is configured to indicate a fault if the following write operation has taken place at an incorrect time and/or using incorrect data after the jump or branch operation has been executed.

Aspect 18: The integrated circuit as claimed in any of Aspects 1-17, wherein the predetermined safety mechanism includes the execution of a hardware-implemented check of jump and/or branch operations, wherein an internal program counter is evaluated for this purpose, wherein the test result stored in the test result register includes the current address entry of the internal program counter, wherein the specified correct test result includes the expected destination address of the jump or branch operation, and wherein the dedicated safety device is configured to indicate a fault if the actual destination address displayed in the internal program counter does not match the expected destination address after the jump or branch operation has been executed.

Aspect 19: The integrated circuit as claimed in any of Aspects 1-18, wherein the predetermined safety mechanism includes the execution of a hardware-implemented check for correct execution of at least one of the following operations: a register access operation, a logical operation, an arithmetic operation, or a comparison operation, wherein a test result stored in the test result register includes an actual result of a respectively executed operation, wherein the specified correct test result includes an expected result of the respectively executed operation, and wherein the dedicated safety device is configured to indicate a fault if the actual test result stored in the test result register does not match the expected test result.

Aspect 20: The integrated circuit as claimed in any of Aspects 1-19, wherein the predetermined safety mechanism includes the execution of a hardware-implemented check of status bits that are actually set by a called operation, wherein the test result stored in the test result register includes a status bit actually set by the called operation, wherein the specified correct test result includes an expected status bit that is expected by the called operation, and wherein the dedicated safety device is configured to indicate a fault when the status bit actually set does not match the expected status bit.

Aspect 21: The integrated circuit as provided in Aspect 20, wherein the status bits that are actually set include at least one of the following flags: a carry flag, a zero flag, or a negative flag.

Aspect 22: The integrated circuit as claimed in any of Aspects 1-21, wherein the predetermined safety mechanism includes a firmware-implemented check of an entire instruction set by loading constant values from different sources, and wherein bitshift operations and/or arithmetic operations are executed using the constant values, wherein a test result stored in the test result register includes an actually obtained result of a respectively executed operation, wherein the specified correct test result includes an expected result of the respectively executed operation, and wherein the dedicated safety device is configured to indicate a fault when the result actually obtained does not match the expected result.

Aspect 23: The integrated circuit as claimed in any of Aspects 1-22, wherein the dedicated safety device is configured to execute the predetermined safety mechanism using only a predetermined subset of all of the operations present in an entire instruction set.

Aspect 24: The integrated circuit as provided in Aspect 23, wherein the dedicated safety device is configured to detect more than a predefined number of randomly occurring hardware faults in the associated ALU using a predetermined subset of operations.

Aspect 25: The integrated circuit as claimed in any of Aspects 1-24, wherein the dedicated safety device is configured to repeat the reading out of the content of the test result register and the comparison with the specified correct test result in a safety-critical time interval, which is significantly shorter than a predefined fault handling time interval.

Aspect 26: The integrated circuit as provided in Aspect 25, wherein the predefined fault handling time interval is a fault handling time interval (FHTI) defined in the ISO 26262:2018 standard.

Aspect 27: A method for continuously monitoring a functional safety of a specific digital signal processor installed in an integrated circuit, wherein the method is carried out using a dedicated safety device and includes the following steps: periodic execution of a built-in safety mechanism, wherein the built-in safety mechanism allows one or more specified test operations to be carried out by an associated arithmetic logic unit (ALU) integrated in the specific digital signal processor, and test results obtained from the one or more specified test operations are stored in a test result register, reading out content of the test result register at specified times, comparing the content with a specified correct test result, and generating a fault indication in the event of a detected deviation between the specified correct test result and the content read from the test result register.

Aspect 28: A non-transitory computer-readable medium comprising a computer program having a program code for causing a computer system to execute a method for continuously monitoring a functional safety of a specific digital signal processor installed in an integrated circuit, wherein the method is carried out using a dedicated safety device, and wherein the method comprises: periodic execution of a built-in safety mechanism, wherein the built-in safety mechanism allows one or more specified test operations to be carried out by an associated arithmetic logic unit (ALU) integrated in the specific digital signal processor, and test results obtained from the one or more specified test operations are stored in a test result register, reading out content of the test result register at specified times, comparing the content with a specified correct test result, and generating a fault indication in the event of a detected deviation between the specified correct test result and the content read from the test result register.

Aspect 29: A system configured to perform one or more operations recited in one or more of Aspects 1-28.

Aspect 30: An apparatus comprising means for performing one or more operations recited in one or more of Aspects 1-28.

Aspect 31: A non-transitory computer-readable medium storing a set of instructions, the set of instructions comprising one or more instructions that, when executed by a device, cause the device to perform one or more operations recited in one or more of Aspects 1-28.

Aspect 32: A computer program product comprising instructions or code for executing one or more operations recited in one or more of Aspects 1-28.

1. A hardware-implemented integrated circuit comprising:
a specific digital signal processor having an associated arithmetic logic unit (ALU), and
a dedicated safety device for continuously monitoring a functional safety of the specific digital signal processor,
wherein the specific digital signal processor is configured to:
repeatedly execute a predetermined safety mechanism, wherein the predetermined safety mechanism enables one or more specified test operations to be carried out by the associated ALU, and wherein test results obtained from the one or more specified test operations are stored in a test result register, and
wherein the dedicated safety device is configured to:
read out at certain times content of the test result register, compare the content with a specified correct test result, and, in the event of a deviation of the content from the specified correct test result, generate a fault indication.

2. The integrated circuit as claimed in claim 1,
wherein the specified correct test result is calculated in advance and stored in a memory.

3. The integrated circuit as claimed in claim 1,
wherein the specified correct test result is stored in a register bank.

4. The integrated circuit as claimed in claim 1,
wherein the dedicated safety device is in the form of a hardware block coupled to the specific digital signal processor, and
wherein the security mechanism is implemented in the form of firmware integrated in the hardware block.

5. The integrated circuit as claimed in claim 1,
wherein the dedicated safety device includes a diverse implementation of the predetermined safety mechanism.

6. The integrated circuit as claimed in claim 1,
wherein the predetermined safety mechanism involves the execution of a single operation,
wherein a test result stored in the test result register includes an actual result of the single operation, and
wherein the specified correct test result includes a precalculated expected result of the single operation.

7. The integrated circuit as claimed in claim 1,
wherein the predetermined safety mechanism involves the execution of multiple single operations,
wherein the test results stored in the test result register include actual individual results of the multiple single operations, and the actual individual results are stored in a compressed manner in a readable code.

8. The integrated circuit as claimed in claim 7,
wherein the readable code is a checksum.

9. The integrated circuit as claimed in claim 1,
wherein the dedicated safety device is configured to delete the test result register during or after readout of the test result register so that a new test result can then be stored in the test result register.

10. The integrated circuit as claimed in claim 1,
wherein the predetermined safety mechanism includes a sequential execution of a sequence of operations,
wherein the test results stored in the test result register include individual, sequentially listed, actual results of the sequence of operations, and
wherein the dedicated safety device has a sequence counter which is configured to count an execution of the sequence of operations and monitor whether the sequence of operations have been executed sequentially.

11. The integrated circuit as claimed in claim 10,
wherein the sequence counter is configured to monitor a correct sequential execution by matching the individual, sequentially listed, actual results of the sequence of operations with respective pre-stored expected results according to a current counter reading of the sequence counter.

12. The integrated circuit as claimed in claim 1,
wherein the one or more specified operations executed by the associated ALU include at least one command for performing an arithmetic calculation.

13. The integrated circuit as claimed in claim 1,
wherein the one or more specified operations executed by the associated ALU include at least one LOAD command or a STORE command.

14. The integrated circuit as claimed in claim 1,
wherein the one or more specified operations executed by the associated ALU include at least one JUMP command or a MOVE command.

15. The integrated circuit as claimed in claim 1,
wherein the predetermined safety mechanism includes the execution of a hardware-implemented verification of memory access operations, wherein a memory bus is monitored for this purpose in order to detect faults that occur in an address decoder,
wherein a test result stored in the test result register includes a memory actually executed access operation stored on the memory bus,
wherein the specified correct test result is an expected memory access operation, and
wherein the dedicated safety device is configured to indicate a fault if an incorrect memory access operation is detected during the execution of the predetermined safety mechanism.

16. The integrated circuit as claimed in claim 1,
wherein the predetermined safety mechanism includes the execution of a hardware-implemented stuck-at check on the address bus by using two specific registers located at complementary addresses, wherein, in the case of a stuck-at fault of an address bit in one of the registers, the register in question can no longer be addressed, and
wherein the dedicated safety device is configured to indicate a fault when a stuck-at fault is detected on the address bus.

17. The integrated circuit as claimed in claim 1,
wherein the predetermined safety mechanism includes the execution of a hardware-implemented check of jump and/or branch operations, wherein, for this purpose, a memory bus is monitored to determine whether a subsequent write operation takes place at a correct time and/or is using correct data after a jump or branch operation has been executed,
wherein the test result stored in the test result register contains the actual time and/or the actual data set of the subsequent write operation,
wherein the specified correct test result includes an expected time and/or an expected data set of the subsequent write operation, and
wherein the dedicated safety device is configured to indicate a fault if the following write operation has taken place at an incorrect time and/or using incorrect data after the jump or branch operation has been executed.

18. The integrated circuit as claimed in claim 1,
wherein the predetermined safety mechanism includes the execution of a hardware-implemented check of jump and/or branch operations, wherein an internal program counter is evaluated for this purpose,
wherein the test result stored in the test result register includes the current address entry of the internal program counter,
wherein the specified correct test result includes the expected destination address of the jump or branch operation, and
wherein the dedicated safety device is configured to indicate a fault if the actual destination address displayed in the internal program counter does not match the expected destination address after the jump or branch operation has been executed.

19. The integrated circuit as claimed in claim 1,
wherein the predetermined safety mechanism includes the execution of a hardware-implemented check for correct execution of at least one of the following operations:
a register access operation,
a logical operation,
an arithmetic operation, or
a comparison operation,
wherein a test result stored in the test result register includes an actual result of a respectively executed operation,
wherein the specified correct test result includes an expected result of the respectively executed operation, and
wherein the dedicated safety device is configured to indicate a fault if the actual test result stored in the test result register does not match the expected test result.

20. The integrated circuit as claimed in claim 1,
wherein the predetermined safety mechanism includes the execution of a hardware-implemented check of status bits that are actually set by a called operation,
wherein the test result stored in the test result register includes a status bit actually set by the called operation,
wherein the specified correct test result includes an expected status bit that is expected by the called operation, and
wherein the dedicated safety device is configured to indicate a fault when the status bit actually set does not match the expected status bit.

21. The integrated circuit as claimed in claim 20,
wherein the status bits that are actually set include at least one of the following flags:
a carry flag,
a zero flag, or
a negative flag.

22. The integrated circuit as claimed in claim 1,
wherein the predetermined safety mechanism includes a firmware-implemented check of an entire instruction set by loading constant values from different sources, and wherein bitshift operations and/or arithmetic operations are executed using the constant values,
wherein a test result stored in the test result register includes an actually obtained result of a respectively executed operation,
wherein the specified correct test result includes an expected result of the respectively executed operation, and
wherein the dedicated safety device is configured to indicate a fault when the result actually obtained does not match the expected result.

23. The integrated circuit as claimed in claim 1,
wherein the dedicated safety device is configured to execute the predetermined safety mechanism using only a predetermined subset of all of the operations present in an entire instruction set.

24. The integrated circuit as claimed in claim 23,
wherein the dedicated safety device is configured to detect more than a predefined number of randomly occurring hardware faults in the associated ALU using a predetermined subset of operations.

25. The integrated circuit as claimed in claim 1,
wherein the dedicated safety device is configured to repeat the reading out of the content of the test result register and the comparison with the specified correct test result in a safety-critical time interval, which is significantly shorter than a predefined fault handling time interval.

26. The integrated circuit as claimed in claim 25,
wherein the predefined fault handling time interval is a fault handling time interval defined in the ISO 26262:2018 standard.

27. A method for continuously monitoring a functional safety of a specific digital signal processor installed in an integrated circuit, wherein the method is carried out using a dedicated safety device and includes the following steps:
periodic execution of a built-in safety mechanism, wherein the built-in safety mechanism allows one or more specified test operations to be carried out by an associated arithmetic logic unit (ALU) integrated in the specific digital signal processor, and test results obtained from the one or more specified test operations are stored in a test result register,
reading out content of the test result register at specified times,
comparing the content with a specified correct test result, and
generating a fault indication in the event of a detected deviation between the specified correct test result and the content read from the test result register.

28. A non-transitory computer-readable medium comprising a computer program having a program code for causing a computer system to execute a method for continuously monitoring a functional safety of a specific digital signal processor installed in an integrated circuit, wherein the method is carried out using a dedicated safety device, and wherein the method comprises:
periodic execution of a built-in safety mechanism, wherein the built-in safety mechanism allows one or more specified test operations to be carried out by an associated arithmetic logic unit (ALU) integrated in the specific digital signal processor, and test results obtained from the one or more specified test operations are stored in a test result register,
reading out content of the test result register at specified times,
comparing the content with a specified correct test result, and
generating a fault indication in the event of a detected deviation between the specified correct test result and the content read from the test result register.
